(19) United States
(12) Patent Application Publication
(10) Pub. No.: US 2023/0295456 A1
(43) Pub. Date: Sep. 21, 2023

(54) SURFACE-ERODING PHOTO-CURABLE ACRYLATED AND METHACRYLATED ANHYDRIDE BASED RESINS

(71) Applicant: SOUTH DAKOTA BOARD OF REGENTS, Pierre, SD (US)

(72) Inventors: WHYTNEIGH DUFFIE, Rapid City, SD (US); TRAVIS WALKER, Rapid City, SD (US); TSVETANKA FILIPOVA, RAPID CITY, SD (US); TIMOTHY BRENZA, Rapid City, SD (US); KEVIN BARZ, Rapid City, SD (US)

(21) Appl. No.: 18/185,152

(22) Filed: Mar. 16, 2023

Related U.S. Application Data
(60) Provisional application No. 63/269,417, filed on Mar. 16, 2022.

(51) Int. Cl. C09D 135/02; C08F 22/04; C09D 4/00; B33Y 70/00

(52) U.S. Cl. CPC C09D 135/02; C08F 22/04; C09D 4/00; B33Y 70/00

(57) ABSTRACT

The present disclosure relates to photo-curable resins, and, more particularly, to 3D-printable, surface-eroding, acrylic anhydride-based resins, including both acrylated and methacrylated chemistries. In a preferred embodiment, the resins compositions are degradeable. The disclosure also provides methods of preparing the photo-curable resins and embodiments of degradeable objects comprised of the photo-curable resins.

### CROSS REFERENCE TO RELATED APPLICATIONS

This application is related to and claims priority under 35 U.S.C. § 119 to U.S. Provisional Application Ser. No. 63/269,417 filed on Mar. 16, 2022, entitled “SURFACE-ERODING PHOTO-CURABLE ACRYLATED AND METHACRYLATED ANHYDRIDE BASED RESINS.” The entire contents of this patent application are hereby expressly incorporated herein by reference including, without limitation, the specification, tables, examples, claims, and abstract.

### GRANT REFERENCE

Work for this invention was funded in part by grants from National Science Foundation, Grant No. 1828462. The United States government may have certain rights in this invention.

### TECHNICAL FIELD

The present disclosure relates to photo-curable resins, and, more particularly, to 3D-printable, surface-eroding, acrylic anhydride-based resins, including both acrylated and methacrylated chemistries.

### BACKGROUND

Development of 3D-printable thermosets and thermoplastics that chemically degrade in the presence of water in a controlled, predictive manner has been postulated as a strategy to engineer a number of advanced composites, including biological tissue scaffolds, exposure-dependent security inks, disposable single-use medical devices, and time-dependent energetic containers. Although intense research has been completed on utilizing photochemical techniques to selectively solidify bulk-degrading resin formulations for large-scale applications (e.g., sacrificial molds for injection molding), significant challenges exist, such as intense swelling of the crosslinked matrix, which limits the suitability of these materials for small-scale applications (e.g., soft-lithography, microfluidics, sensors). Thus, the lack of synthesis routes to produce commercially available resin formulations for high-resolution and minimal-swelling applications poses a significant gap in current literature and industrial-scale applications.

### BRIEF SUMMARY OF THE PREFERRED EMBODIMENTS

An advantage of this disclosure is that the compositions and methods described herein provide photo-curable resin compositions (i.e., resin compositions that undergo light-activated polymerization). It is an advantage of the disclosure that the resin compositions can be compatible for 3D printing. Further, preferred embodiments can be degradable. Other properties and features are disclosed further herein.

A preferred embodiment comprises a photo-curable resin composition comprising a methacrylated anhydride of formula (I)

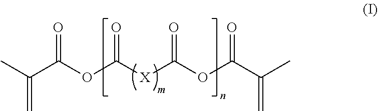

or an acrylated anhydride of formula (II)

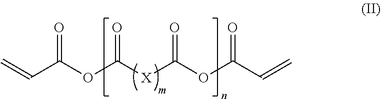

wherein X is a carbon, a C2-C12 alkane, or a C2-C12 alkene; and wherein n is an integer of 1 or more. In a preferred embodiment, X is a C4 alkane, C5 alkane, C6 alkane, C9 alkane, or C10 alkane. In a preferred embodiment, n is 1, 2, 3, 4, 5, or 6.

A preferred embodiment comprises a degradable three-dimensional object comprising a photo-curable resin composition comprising a methacrylated anhydride of formula (I)

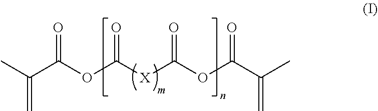

or an acrylated anhydride of formula (II)

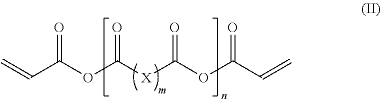

wherein X is a carbon, a C2-C12 alkane, or a C2-C12 alkene; and wherein n is an integer of 1 or more; wherein the composition has been cured by exposure to light having a wavelength of from about 250 nm to about 450 nm or from about 780 nm to about 800 nm.

A preferred embodiment a method of preparing a degradable three-dimensional object, the method comprising providing a photo-curable resin composition and a photoinitiator, wherein the photo-curable resin composition comprises a methacrylated anhydride of formula (I)

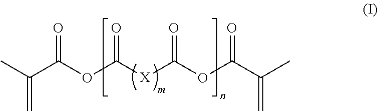

or an acrylated anhydride of formula (II)

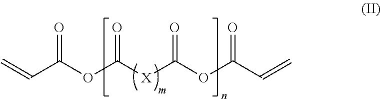

wherein X is a carbon, a C2-C12 alkane, or a C2-C12 alkene; and wherein n is an integer of 1 or more; and forming a two-dimensional or three-dimensional object from the composition; and exposing the object to light to cure the composition.

While multiple embodiments are disclosed, still other embodiments of the present invention will become apparent to those skilled in the art from the following detailed description, which shows and describes illustrative embodiments of the invention. Accordingly, the figures and detailed description are to be regarded as illustrative in nature and not restrictive.

### BRIEF DESCRIPTION OF THE FIGURES

The figures described herein form part of the specification and are included to further demonstrate certain preferred embodiments of the inventions. In some instances, embodiments of the inventions can be best understood by referring to the accompanying figures in combination with the detailed description presented herein. The description and accompanying figures may highlight a certain specific example, or a certain aspect of the inventions. However, one skilled in the art will understand that portions of the example or aspect may be used in combination with other embodiments of the inventions.

FIG. 1 is an overview of the synthesis route. The dicarboxylic acid precursor is reacted with acetic anhydride to produce the anhydride functionality. The polyanhydride is then reacted with methacrylic acid to produce the methacrylate end groups. The methacrylated polyanhydride is incorporated into a photopolymer resin and used to produce thermoset samples by a stereolithography method.

FIG. 2 shows photos of the step 1 (S1) and step 2 (S2) products. All products were solid waxy solids of differing hardness. The suberic product was the softest, and the dodecanedioic was the hardest based on physical observation.

FIG. 3 shows FTIR of precursor, step 1, and step 2 products. The top illustration shows the FTIR of the dicarboxylic acid used, consisting of a broad carboxylic —OH stretch (3300-2500 cm⁻¹) and carboxylic C═O stretch (1725-1700 cm⁻¹). After the step 1 synthesis the two characteristic bands for the diacid disappear and the characteristic anhydride symmetric and asymmetric C═O stretches (1850-1800 cm-1 and 1790-1740 cm⁻¹ respectively) appear. After the step 2 synthesis the methacrylate C═C stretch (1630-1640 cm⁻¹) appears.

FIG. 4A and FIG. 4B show NMR of step 1 polyanhydride products and NMR of step 2 polyanhydride products, respectively. The hydrogens depicted on the structure are labeled and associate to the corresponding peak.

FIG. 5 shows 10-50 wt % loadings of synthesized polyanhydride. The 40 and 50 wt % resins show synthesized polyanhydride crashing out of solution after 24 hours at room temperature.

FIG. 6 shows a 50-hour degradation study of the different polyanhydrides that were synthesized. The suberic degradation had a slope of 0.37 with an R2 of 0.97, The sebacic degradation had a slope of 0.29 with an R2 of 0.97, and the dodecanedioic degradation had a slope of 0.17 with an R2 of 0.97.

FIG. 7 shows disks of the different polyanhydride formulations after degradation and drying at various times. Cracking of the surface layer was longer for the polyanhydrides that had lower degradation rates.

### DETAILED DESCRIPTION

The present disclosure relates to hydrolytically degradable functionalized anhydride compounds that can be incorporated into photopolymer resins for use in additive-manufacturing techniques. The anhydride oligomer provides a sacrificial linkage for chemical degradation upon exposure to water, and the functional acrylate or methacrylate group provides utilization via photopolymerization.

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

It is to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Similarly, the word “or” is intended to include “and” unless the context clearly indicate otherwise. The word “or” means any one member of a particular list and also includes any combination of members of that list. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1%, and 4% This applies regardless of the breadth of the range.

The term “about,” as used herein, refers to variation in the numerical quantity that can occur, for example, through typical measuring techniques and equipment, with respect to any quantifiable variable, including, but not limited to, mass, volume, time, temperature, and molecular weight. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. The term “about” also encompasses amounts that differ due to different equilibrium conditions for a composition resulting from a particular initial mixture. Whether or not modified by the term “about,” the claims include equivalents to the quantities.

The methods and compositions of the present invention may comprise, consist essentially of, or consist of the components and ingredients of the present invention as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

### Photo-Curable Resin Compositions

The present disclosure provides photo-curable resin compositions (i.e., resin compositions that undergo light-activated polymerization). The photo-curable resin compositions comprise a methacrylated anhydride of formula (I):

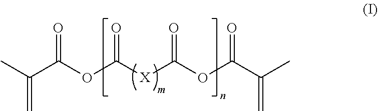

or an acrylated anhydride of formula (II):

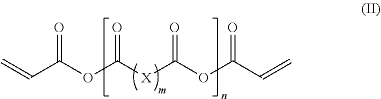

In both Formula I and II, X can be a carbon, a C2-C12 alkane, or a C2-C12 alkene, and n represents an integer of 1 or more, including, but not limited to 1, 2, 3, 4, 5, 6, 7, 8, 9, 10, 11, 12, 13, 14, 15, 16, 17, 18, 19, 20, or greater. In some embodiments where X is an alkane, the alkane can have an aromatic group attached; for example, terephthalic acid, 1,3-bis(carboxyphenoxy)propane, 1,6-bis(carboxyphenoxy)hexane.

In a preferred embodiment, a methacrylated anhydride has formula (III)

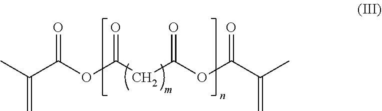

where m is an integer of 0, 1, 2, 3, 4, 5, 6, 7, 8, 9, 10, 11, or 12; and where n is an integer of 1 or greater, including, but not limited to 1, 2, 3, 4, 5, 6, 7, 8, 9, 10, 11, 12, 13, 14, 15, 16, 17, 18, 19, 20, or greater.

In a preferred embodiment, an acrylated anhydride has formula (IV)

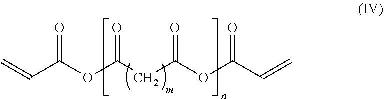

where m is an integer of 0, 1, 2, 3, 4, 5, 6, 7, 8, 9, 10, 11, or 12; and where n is an integer of 1 or greater, including, but not limited to 1, 2, 3, 4, 5, 6, 7, 8, 9, 10, 11, 12, 13, 14, 15, 16, 17, 18, 19, 20, or greater.

The anhydrides can be synthesized in a two-stage process—homopolymer condensation of a diacid (HO₂C—R—CO₂H, wherein R═(CH₂)ₘ) and a subsequent acrylation or methacrylation. Below is an example include a methacrylation step to form the methacrylate anhydride.

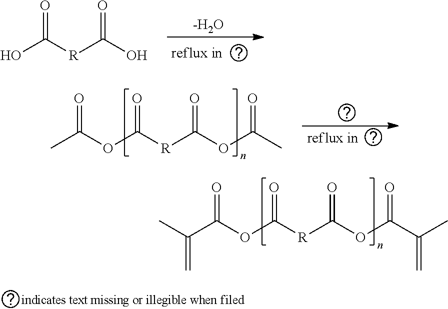

The number of repeating units (n) between anhydride end-groups can be controlled by modifying the reflux time (step 1), while chemical composition of the oligomer backbone is set by the starting diacid (R). Examples of diacid precursors include those provided in Table 1.

TABLE 1

| Precursor | | |
|---|---|---|
| Common name | IUPAC name | m repeat |
| Oxalic acid | ethanedioic acid | 0 |
| Malonic acid | propanedioic acid | 1 |
| Succinic acid | butanedioic acid | 2 |
| Glutaric acid | pentanedioic acid | 3 |
| Adipic acid | hexanedioic acid | 4 |
| Pimelic acid | heptanedioic acid | 5 |
| Suberic acid | octanedioic acid | 6 |
| Azelaic acid | nonanedioic acid | 7 |
| Sebacic acid | decanedioic acid | 8 |
| | undecanedioic acid | 9 |
| | dodecanedioic acid | 10 |
| Brassylic acid | tridecanedioic acid | 11 |
| | tetradecanedioic acid | 12 |

In some embodiments, the photo-curable resin composition comprises one or more methacrylated anhydrides of formula (I), wherein X is a carbon, a C2-C12 alkane, or a C2-C12 alkene; and n represents an integer of 1 or more, including, but not limited to 1, 2, 3, 4, 5, 6, 7, 8, 9, 10, 11, 12, 13, 14, 15, 16, 17, 18, 19, 20, or greater. In a most preferred embodiment n is 1, 2, 3, 4, 5, or 6.

In some embodiments, the photo-curable resin composition comprises one or more acrylated anhydrides of formula (II), wherein X is a carbon, a C2-C12 alkane, or a C2-C12 alkene; and n represents an integer of 1 or more, including, but not limited to 1, 2, 3, 4, 5, 6, 7, 8, 9, 10, 11, 12, 13, 14, 15, 16, 17, 18, 19, 20, or greater. In a most preferred embodiment n is 1, 2, 3, 4, 5, or 6.

In some embodiments, the photo-curable resin composition comprises one or more methacrylated anhydrides of formula (III), wherein m is 0, 1, 2, 3, 4, 5, 6, 7, 8, 9, 10, 11, 12, or mixtures thereof. In a most preferred embodiment, m is 4, 5, 6, 9, or 10. In a most preferred embodiment n is 1, 2, 3, 4, 5, or 6.

In some embodiments, the photo-curable resin composition comprises one or more acrylated anhydrides of formula (IV), wherein m is 0, 1, 2, 3, 4, 5, 6, 7, 8, 9, 10, 11, 12, or mixtures thereof. In a most preferred embodiment, m is 4, 5, 6, 9, or 10. In a most preferred embodiment n is 1, 2, 3, 4, 5, or 6.

In some embodiments, the photo-curable resin composition comprises from about 0.5 to about 99.5 wt % of the acrylated or methacrylated anhydride, from about 1 to about 99 wt % of the acrylated or methacrylated anhydride, from about 10 to about 95 wt % of the acrylated or methacrylated anhydride, from about 20 to about 90 wt % of acrylated or methacrylated anhydride, from about 25 to about 60 wt % of the acrylated or methacrylated anhydride, or from about 35 to about 50 wt % of the acrylated or methacrylated anhydride. In certain embodiments, the photo-curable resin composition comprises from about 5 to about 30 wt % of the acrylated or methacrylated anhydride. In certain embodiments, the photo-curable resin composition comprises about 10 wt %, about 20 wt %, about 30 wt %, about 40 wt %, or about 50 wt % the acrylated or methacrylated anhydride.

The oligomers formed by this synthesis method can be in solid form at room temperature and ambient conditions, such as a waxy solid resin, or in liquid form at room temperature and ambient conditions. In particular we have found that where X is a methyl, ethyl, or propyl, the oligomer is a liquid; if X is a C4-C12 alkane, the oligomer is a solid resin.

### Photoinitiators

In certain embodiments, the photo-curable resin compositions comprise a photoinitiator. Photoinitiators may be useful for various purposes, including for curing of polymers, including those that can be activated with light and initiate polymerization of the polymerizable components of the formulation. Examples of the photoinitiators include aromatic ketones, acylphosphine oxide compounds, aromatic onium salt compounds, organic peroxides, thio compounds (thioxanthone compounds, thiophenyl group-containing compounds, and the like), hexaaryl biimidazole compounds, ketoxime ester compounds, borate compounds, azinium compounds, metallocene compounds, active ester compounds, compounds having carbon-halogen bonds, and alkylamine compounds.

Examples of suitable photoinitiators include acetophenone, acetophenone benzyl ketal, 1-hydroxycyclohexyl phenyl ketone, 2,2-dimethoxy-2-phenyl acetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholino-propan-1-one, bis(2,4,6-trimethylbenzoyl)-phenylphosphine oxide, 2,4,6-trimethylbenzoyl-diphenyl-phosphine oxide, 2,4-diethylthioxanthone, and bis-(2,6-dimethoxybenzoyl)-2,4,4-trimethylpentyl phosphine oxide. Combinations comprising one or more the foregoing may also be used.

Examples of commercial products of the photoinitiator include IRGACURE 651 (2,2-dimethoxy-1,2-diphenylethan-1-one), IRGACURE 184 (1-hydroxy-cyclohexyl-phenyl-ketone), DAROCUR 1173 (2-hydroxy-2-methyl-1-phenyl-propan-1-one), IRGACURE 2959 (1-[4-(2-hydroxyethoxy)-phenyl]-2-hydroxy-2-methyl-1-propan-1-one), IRGACURE 127 (2-hydroxy-1-{4-[4-(2-hydroxy-2-methyl-propionyl)-benzyl]phenyl]-2-methyl-propan-1-one}, IRGACURE 907 (2-methyl-1-(4-methylthiophenyl)-2-morpholinopropan-1-one), IRGACURE 369 (2-benzyl-2-dimethylamino-1-(4-morpholinophenyl)-butanone-1), IRGACURE 379 (2-(dimethylamino)-2-[(4-methylphenyl)methyl]-1-[4-(4-morpholinyl)phenyl]-1-butanone), DAROCUR TPO (2,4,6-trimethylbenzoyl-diphenyl-phosphine oxide), IRGACURE 819 (bis(2,4,6-trimethylbenzoyl)-phenylphosphine oxide), IRGACURE 784 (bis(135-2,4-cyclopentadien-1-yl)-bis(2,6-difluoro-3-(1H-pyrrol-1-yl)-phenyl)titanium), IRGACURE OXE 01 (1.2-octanedione, 1-[4-(phenylthio)-, 2-(0-benzoyloxime)]), IRGACURE OXE 02 (ethanone, 1-[9-ethyl-6-(2-methylbenzoyl)-9H-carbazol-3-yl]-, 1-(0-acetyloxime)), and IRGACURE 754 (mixture of oxyphenylacetic acid, 2-[2-oxo-2-phenylacetoxyethoxy]ethyl ester and oxyphenylacetic acid, and 2-(2-hydroxyethoxy)ethyl ester) (trade names, manufactured by BASF Corporation), KAYACURE DETX-S (2,4-diethylthioxanthone) (trade name, manufactured by Nippon Kayaku Co., Ltd.), Speedcure TPO (2,4,6-trimethylbenzoyldiphenyl-phosphine oxide) and Speedcure DETX (2,4-diethylthioxanthen-9-one) (trade name, manufactured by Lambson Ltd.), Lucirin TPO, LR8893, and LR8970 (trade names, manufactured by BASF Corporation), and UBECRYL P36 (trade name, manufactured by UCB Corporation). These photoinitiators may be used alone or in combination of two or more. In certain embodiments, the photoinitiator comprises IRGACURE 819 (bis(2,4,6-trimethylbenzoyl)-phenylphosphine oxide).

In a most preferred embodiment, the photoinitiator comprises Irgacure 819, Irgacure 1173, Irgacure 2959, Irgacure 651, TPO-L, Ivocerin, BAPO, or a mixture thereof.

In some embodiments, the photoinitiator initiates photopolymerization using light energy. In certain embodiments, the photoinitiator initiates photopolymerization with exposure to light energy from 800 nm to 250 nm, from 800 nm to 350 nm, from 800 nm to 450 nm, from 800 nm to 550 nm, from 800 nm to 650 nm, from 600 nm to 250 nm, from 600 nm to 350 nm, from 600 nm to 450 nm, or from 400 nm to 250 nm.

In some embodiments, the photo-curable resin composition comprises from about 0.01 to about 15 wt %, from about 0.02 to about 10 wt %, from about 0.05 to about 5 wt %, from about 0.1 to about 3 wt %, from about 0.1 to about 2 wt %, or from about 0.1 to about 1 wt % of the photoinitiator.

### Reactive Diluents

The photo-curable resin compositions may comprise a reactive diluent. A “reactive diluent” as used herein refers to a substance which reduces the viscosity of another substance, such as a monomer or a curable resin. A reactive diluent may become part of another substance, such as a polymer obtained by a polymerization process. In some embodiments, a reactive diluent is a curable monomer which, when mixed with a photo-curable resin, reduces the viscosity of the resultant formulation and is incorporated into the polymer that results from polymerization of the formulation. The reactive diluent typically has a low viscosity. One or more reactive diluents may be included in the composition to reduce the viscosity of the photo-curable resin, e.g., to a viscosity less than the viscosity of the photo-curable resin in the absence of the reactive diluent.

In some embodiments, the reactive diluent comprises an acrylate, a methacrylate, an epoxide, or a combination thereof. As used herein, a “(meth)acrylate” (and variations thereof) is an acrylate, a methacrylate, or a combination thereof. In some embodiments, the reactive diluent comprises a (meth)acrylate, a di(meth)acrylate, a di(meth)acrylate of polyglycols, a hydrobenzoic acid ester (meth)acrylate, a cycloalkyl-2-, 3-, or 4-((meth)acryloxy)benzoate, isobornyl (meth)acrylate, trimethylolpropane tri(meth)acrylate, triethylene glycol di(meth)acrylate (e.g., TEGDMA), 1,12-dodecanediol di(meth)acrylate (e.g., D4MA), 3,3,5-trimethcyclohexyl 2-((meth)acryloxy) benzoate (e.g., HSMA), benzyl salicylate (meth)acrylate (e.g., BSMA), 3,3,5-Trimethylcyclohexyl (meth)acrylate, tripropylene glycol di(meth)acrylate, hexane-1,6-diol di(meth)acrylate, tricyclodecanedimethanol di(meth)acrylate, tricyclodecanedimethanol di(meth)acrylate, hydroxyethyl (meth)acrylate, benzyl (meth)acrylate, a (poly)vinyl monomer, a derivative thereof, or a combination thereof. In certain embodiments, the reactive diluent comprises methacrylic anhydride.

### Additional Additives

The photo-curable resin compositions can further include additional additives as desired. Useful additives include, but are not limited to, carbon nanofibers, a dye, a filler (including, but not limited to, calcium carbonate), graphene, magnetic particles, a pigment, a polymerization inhibitor, polyvinylpyrrolidone, a surface energy modifier, a biologically significant chemical, among others.

In some embodiments, the photo-curable resin composition comprises a filler. In some embodiments, the filler comprises calcium carbonate (i.e., chalk), kaolin, metakolinite, a kaolinite derivative, magnesium hydroxide (i.e., talc), calcium silicate (i.e., wollastonite), a glass filler (e.g., glass beads, short glass fibers, or long glass fibers), a nanofiller (e.g., nanoplates, nanofibers, or nanoparticles), a silica filler (e.g., a mica, silica gel, fumed silica, or precipitated silica), carbon black, dolomite, barium sulfate, ATH Al(OH)₃, MDH Mg(OH)₂, diatomaceous earth, magnetite, halloysite, zinc oxide, titanium dioxide, cellulose, lignin, a carbon filler (e.g., chopped carbon fiber or carbon fiber), a derivative thereof, or a combination thereof.

In some embodiments, the photo-curable resin composition comprises a pigment, a dye, or a combination thereof. A pigment is typically a suspended solid that may be insoluble in the resin. A dye is typically dissolved in the resin. In some embodiments, the pigment comprises an inorganic pigment. Preferred inorganic pigments include, but are not limited to, aluminum pigments, cadmium pigments, carbon pigments, chromium pigments, cobalt pigments, copper pigments, iron oxide pigments, lead pigments, manganese pigments, mercury pigments, titanium pigments, ultramarine pigments, zinc pigments, and mixtures or combinations thereof.

In some embodiments, the inorganic pigment comprises aluminum flake, aluminum powder, antimony trioxide, barium sulfide, carbon black, chrome green, chrome yellow, iron oxide, a yellow iron oxide, zinc oxide, a red iron oxide, ferric ammonium ferrocyanide, titanium dioxide, cadmium yellow, cadmium red, cadmium green, cadmium orange, cadmium sulfoselenide, cobalt violet, cobalt blue, cerulean blue, cobalt yellow, azurite, Han purple, Han blue, Egyptian blue, malachite, Paris green, phthalocyanine Blue BN, phthalocyanine Green G, verdigris, sanguine, caput mortuum, oxide red, red ochre, yellow ochre, Venetian red, Prussian blue, raw sienna, burnt sienna, raw umber, burnt umber, lead white, cremnitz white, Naples yellow, red lead, lead-tin-yellow, manganese violet, YInMn blue, titanium beige, titanium dioxide, titanium white, titanium yellow, vermillion, zinc white, zinc ferrite, zinc yellow. In some embodiments, the pigment comprises an organic pigment. In some embodiments, the organic pigment comprises an azo pigment, an anthraquinone pigment, a copper phthalocyanine (CPC) pigment (e.g., phthalo blue or phthalo green) or a combination thereof.

In some embodiments, the dye comprises an azo dye (e.g., a diarylide or Sudan stain), an anthraquinone (e.g., Oil Blue A or Disperse Red 11), metal organic complexes, naphthalene, spiropyran, an oligoaromatic, or a combination thereof.

In some embodiments, the photo-curable resin composition comprises a surface energy modifier. In some embodiments, the surface energy modifier can aid the process of releasing a polymer from a mold. In some embodiments, the surface energy modifier can act as an antifoaming agent. In some embodiments, the surface energy modifier comprises a defoaming agent, a leveling agent, a wetting agent, or an agent to adjust the flow properties of the photo-curable resin composition. In some embodiments, the surface energy modifier comprises an aloxylated surfactant, a silicone surfactant, a sulfosuccinate, a fluorinated polyacrylate, a fluoropolymer, a silicone, a star-shaped polymer, an organomodified silicone, or any combination thereof.

In some embodiments, the photo-curable resin composition comprises a polymerization inhibitor in order to stabilize the composition and prevent premature polymerization. In some embodiments, the polymerization inhibitor is a photopolymerization inhibitor (e.g., oxygen). In some embodiments, the polymerization inhibitor is a phenolic compound (e.g., BHT, 4-methoxyphenol (MeHQ), or 2,4-dimethyl-6-tert-butylphenol (topanol A)). In some embodiments, the polymerization inhibitor is a stable radical (e.g., 2,2,4,4-tetramethylpiperidinyl-1-oxy radical, 2,2-diphenyl-1-picrylhydrazyl radical, galvinoxyl radical, or triphenylmethyl radical). In some embodiments, more than one polymerization inhibitor is present in the resin. In some embodiments, the polymerization inhibitor acts as a radical scavenger. In certain embodiments, the polymerization inhibitor is an antioxidant, a hindered amine light stabilizer (HAL), a hindered phenol, or a deactivated radical (e.g., a peroxy compound). In some embodiments, the polymerization inhibitor is selected from 4-tert-butylpyrocatechol, tert-butylhydroquinone, 1,4-benzoquinone, 6-tert-butyl-2,4-xylenol, 2-tert-butyl-1,4-benzoquinone, 2,6-di-tert-butyl-p-cresol, 2,6-di-tert-butylphenol, 1,1-diphenyl-2-picrylhydrazyl free radical, hydroquinone, 4-methoxyphenol, phenothiazine, any derivative thereof, and any combination thereof.

In some embodiments, the photo-curable resin composition comprises a biologically significant chemical. In some embodiments, the biologically significant chemical comprises a hormone, an enzyme, an active pharmaceutical ingredient, an antibody, a protein, a drug, or any combination thereof. In some embodiments, the biologically significant chemical comprises a pharmaceutical composition, a chemical, a gene, a polypeptide, an enzyme, a biomarker, an antibiotic, an antimicrobial agent such as a fungicide or bactericide, an analgesic, a medical grade drug, a chemical agent, a bioactive agent, an antibacterial, an antibiotic, an anti-inflammatory agent, an immune-suppressive agent, an immune-stimulatory agent, an immune reagent, an anesthetic, an antioxidant, a lipopolysaccharide complexing agent or a peroxide.

### Degradable Three-Dimensional Objects

The present disclosure provides degradable three-dimensional objects formed from the photo-curable resin compositions disclosed herein. In certain embodiments, the object is formed from the photo-curable resin compositions disclosed herein using 3D printing or photon printing (i.e., with additive manufacturing).

### Objects Incorporating the Resin Compositions

The novel resin formulations incorporating the novel chemical species directly improves present technology by providing a new class of resin formulations utilizing novel ingredients that were previously unavailable due to lack of commercial availability and the lack of synthesis routes to produce these ingredients. The platform chemical technology provides sustainable, biocompatible, and high-resolution photo-curable resins that enable controlled and predictable disappearing of materials, while also retaining mechanical integrity of the material. Potential applications include opportunities for precision casting of pails that are difficult to machine, end-of-life disposal of a part or device (e.g., drone, sensor) in any location to prevent reverse engineering of sensitive technology, transient sensors, advanced reactor design self-healing, sacrificial coatings, and medical devices (e.g., fracture fixation, tissue sealants, drug delivery).

### Methods of Making Degradable Two-Dimensional and Three-Dimensional Objects

The present disclosure provides methods for making or otherwise fabricating degradable two dimensional or three-dimensional objects, wherein the objects are formed from the photo-curable resin compositions disclosed herein.

As discussed herein, a two-dimensional object is generally a coating or layer on another object. Preferred methods of forming a two-dimensional object include, but are not limited to, dip coating, spray coating, blade coating, molding, bulk curing, or a combination thereof.

In some embodiments, the present disclosure provides a method for making a degradable three-dimensional object, the method comprising providing a photo-curable resin composition as described herein and producing an object, wherein producing the object comprises additive manufacturing, molding, bulk curing, or a combination thereof.

In some embodiments, the present disclosure provides a method for forming a degradable three-dimensional object, the method comprising providing a photo-curable resin composition disclosed herein and curing the photo-curable resin composition, thereby forming the degradable three-dimensional object.

In some embodiments, curing the photo-curable resin composition comprises exposing the photo-curable resin composition to a light source. In some embodiments, the curing of the photo-curable resin produces the three-dimensional object. In certain embodiments, the photo-curable resin is cured using an additive manufacturing device to produce the three-dimensional object.

Photopolymerization occurs when suitable formulations (e.g., the photo-curable resin compositions disclosed herein) are exposed to radiation (e.g., UV or visible light) of sufficient power and of a wavelength capable of initiating polymerization. The wavelengths and/or power of radiation useful to initiate polymerization may depend on the photoinitiator used. “Light” as used herein includes any wavelength and power capable of initiating polymerization. Some wavelengths of light include ultraviolet (UV) or visible. UV light sources include UVA (wavelength about 400 nanometers (nm) to about 320 nm), UVB (about 320 nm to about 290 nm) or UVC (about 290 nm to about 100 nm). Any suitable source may be used, including laser sources. The source may be broadband or narrowband, or a combination thereof. The light source may provide continuous or pulsed light during the process. Both the length of time the system is exposed to UV light and the intensity of the UV light can be varied to determine the ideal reaction conditions. Preferred light wavelengths include those from about 250 nm to about 450 nm and from about 780 nm to about 800 nm.

Additive manufacturing includes a variety of technologies which fabricate three-dimensional objects directly from digital models through an additive process. In some embodiments, successive layers of material are deposited and “cured in place”. A variety of techniques are known to the art for additive manufacturing, including selective laser sintering (SLS), fused deposition modeling (FDM) and jetting or extrusion. Selective laser sintering involves using a laser beam to selectively melt and fuse a layer of powdered material according to a desired cross-sectional shape in order to build up the object geometry. Fused deposition modeling involves melting and selectively depositing a thin filament of thermoplastic polymer in a layer-by-layer manner in order to form an object. 3D printing may involve jetting or extruding one or more materials (e.g., the photo-curable resins disclosed herein) onto a build surface in order to form successive layers of the object geometry. The three-dimensional objects may also be fabricated by “vat” processes in which light is used to selectively cure a vat or reservoir of a curable resin (e.g., the resin compositions disclosed herein). Each layer of photo-curable resin may be selectively exposed to light in a single exposure or by scanning a beam of light across the layer. Specific techniques include stereolithography (SLA), Digital Light Processing (DLP) and two photon-induced photopolymerization (TPIP).

### EXAMPLES

### Example 1: Synthesis of Degradable Crosslinking Agent

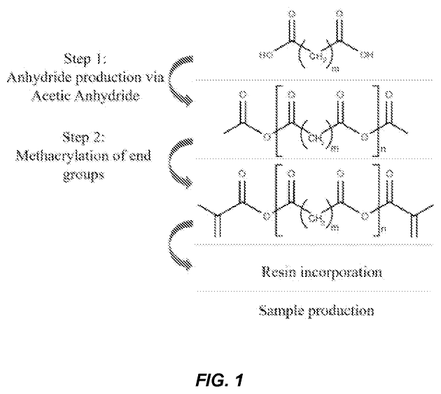

The methacrylated anhydride polymers were produced in a two-part procedure (FIG. 1). Products were synthesized via reflux under an inert atmosphere of nitrogen. In both step 1 (S1) and step 2 (S2), a 1,000 mL RBF was used with a magnetic stir bar and heating mantle. The heating mantle was controlled by the variable power supply, which was set to 10. The stirring of the magnetic stir bar was controlled by a stir plate, which was set to 6 on the stir plate controller. After an hour reflux time the product was transferred to a 500 mL RBF and allowed to cool between 5-20 minutes to make the glassware easier to handle and to prevent bumping when the products were isolated via rotovap. Evaporation was continued until no further solvent condensation was present on the inside of the rotovap condensation tube and no further solvent reflux was observed in the neck of the RBF. To minimize solvent in the product, the RBF was attached for an additional 5 to 15 minutes after no further condensation was observed. The liquid polyanhydride products were then poured into pre-weighed and labeled vials. The products were massed to obtain data on yield within each step of the process. After each step the products were placed into cold storage at 0° C. to prevent further reaction of the product.

### Step 1 Synthesis

The first step involved the step polymerization of the dicarboxylic acid precursor by refluxing in acetic anhydride. A ratio of 10 g of carboxylic acid precursor to 170 mL acetic anhydride. No additional isolation or purification steps were completed. The step 1 product was characterized by TLC, FTIR, and NMR (¹HNMR and ¹³CNMR).

### Step 2 Synthesis

The step 2 synthesis used the step 1 crude anhydride polymer product. Methacrylate end groups were added by refluxing the step 1 product in acetic anhydride and methacrylic acid. The equivalents of methacrylic acid that the step 2 synthesis used was dependent on the ¹HNMR of the step 1 product. The molecular weight of the polyanhydrides was calculated using the ¹HNMR and was used to determine the amount of methacrylic acid that was used in the synthesis. For the sebacic acid, the first aliphatic polymer that was synthesized, 2.5 equivalents of methacrylic acid were used. However, after analysis of this product 5.0 equivalents of methacrylic acid was deemed to have a higher methacrylation concentration as determined from the intensity of the FTIR methacrylate carbon-carbon double bond peak. Thus, the suberic and dodecanedioic step 2 products were synthesized using 5 equivalents of methacrylic acid. Otherwise, the methacrylation procedure occurred identically to the step 1 reflux procedure. The step 2 product was isolated and characterized by TLC, FTIR, NMR (¹HNMR and ¹³CNMR), and DSC. DEPT-135 NMR (300 MHz, 8192 scans, CDCl₃) was also performed for confirmation of peak assignments.

### Characterization Procedure

Thin layer chromatography (TLC) was performed on the products to gain an idea of the purity and chemical species that are present in the step 1 and 2 products. The acid precursor was dissolved in acetone, and the step 1 and step 2 synthesis products were dissolved in DCM before being dotted onto the TLC plate. The plates were then placed in an enclosed system with a solvent system to cause the products to rise through the TLC plate. Two solvent systems were used in analysis of the precursor, step 1, and step 2 products. The first solvent system used 2 mL of butanol, 2 mL of formic acid, 2 mL of water, and 14 mL of xylene, to be used with the comparison of the precursor to the step 1 products and the step 1 with the step 2 products. The second solvent system used 2 mL of butanol, 0.5 mL of formic acid, 1 mL of water, and 14 mL of xylene to be used with the comparison of the step 1 products with the step 2 products.

After determining the purity of the products with TLC, FTIR and NMR were completed. FTIR characterization of the precursors, products, and solvents were obtained by taking a background scan of the environment followed by taking 16 scans of the products by placing them on the FTIR accessory. NMR characterization of the products were obtained by dissolving the step 1 and step 2 synthesis products in deuterated chloroform and running 1024 scans for the ¹HNMR and 8192 scans for the ¹³CNMR.

DSC characterization of the step 2 products were obtained using a 5° C. per minute ramp rate. Starting at room temperature, the sample is cooled to −80° C., kept at this temperature for 3 minutes, raised to 60° C. in the case of suberic products, and to 80° C. in the case of the sebacic and dodecanedioic products, and kept at this temperature for 3 minutes. This thermal cycling is repeated twice more before the test is complete.

### Confirmation of Synthesis Products

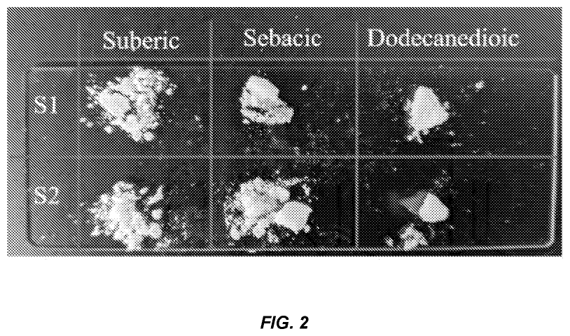

The step 1 and step 2 products appeared to be solid waxy solids after the synthesis (FIG. 2). A noticeable difference in the hardness of the different polyanhydrides existed with the suberic products being the softest materials and the dodecanedioic being the hardest. Furthermore, when trying to pour the polyanhydride materials from the rotavapor flask, issues with dodecanedioic occurred as the material would rapidly solidify. Each step of the polyanhydride synthesis was confirmed using TLC for purity and using FTIR and NMR for chemical and functional identification.

TLC was used to compare the step 1 synthesis products to the precursors. Using solvent system 1, the precursor hardly moved from the origin, whereas significant movement of the step 1 polyanhydride was noted. Furthermore, the step 1 product that was dotted onto the TLC plate did not noticeably separate into multiple dots, and thus, it was determined to be a relatively pure substance. As the step 1 products appeared relatively pure when using TLC, no additional purification or isolation steps were done on any of the step 1 products. TLC for the step 2 synthesis was also achieved with comparison of the step 1 products. Although no significant displacement was observed, no separation of the step 2 product dot on the TLC plate was observed, further indicating that the product is a pure substance.

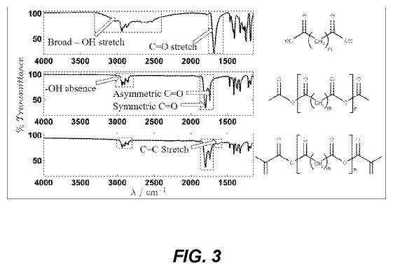

FTIR of the precursor material, step 1, and step 2 products of each of the synthesized products is shown in FIG. 3. Between the precursor and step 1 products of the synthesis, disappearance of the broad carboxylic acid —OH stretch in the 3300-2500 cm⁻¹ region. Furthermore, the separation of carboxylic acid C═O in the 1725-1700 cm⁻¹ to a symmetric and asymmetric stretch of the C═O in the 1850-1800 and 1790-1740 cm⁻¹ regions respectively indicate the presence of an open-chain acid anhydride that is present in the step 1 product. Thus, the step 1 synthesis is observed to have the polyanhydride functionality. In comparing the FTIR results from the step 1 and step 2 product, the appearance of a methacrylate C═C bond is present in the 1630-1640 cm⁻¹ range for the step 2 product, indicating the addition of the methacrylate functionality.

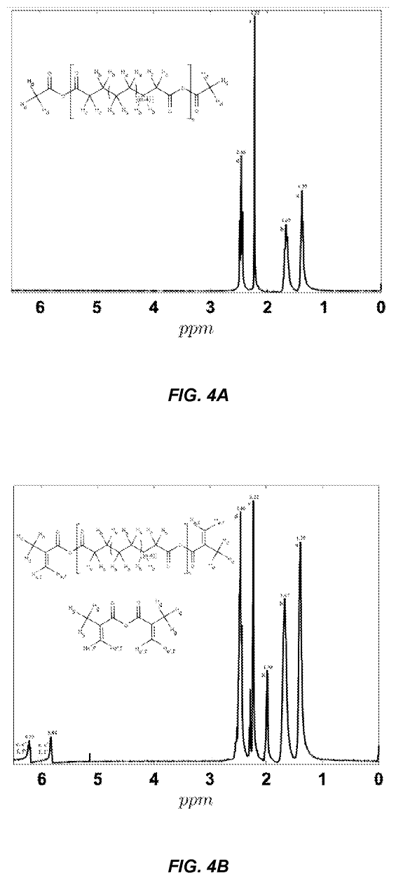

NMR of the step 1 (FIG. 4A), and step 2 (FIG. 4B) products of each of the synthesized polyanhydrides were obtained. The step 1 polyanhydride peak at 2.4-2.6 ppm corresponds to the terminal —CH3/methyl hydrogens that end cap the molecule, the peak at 2.2-2.3 ppm corresponds to the internal —CH2/methylene hydrogens that are closest to the polyanhydride followed by the 1.6-1.8 ppm peak for the methylene groups that are one carbon away from the anhydride group, and lastly the peak at 1.3-1.5 ppm indicates the peak for all other internal carbons that are far enough removed from the deshielding effects of the anhydride functionality. Using the step 1 ¹HNMR, the n-value, the number of times the polyanhydride repeats, was calculated. The n value was determined to be approximately 1.6 on average for each of the step 1 polyanhydrides that were synthesized. With the n-value ascertained, a molecular weight for the species could then be calculated, and furthermore, the amount of methacrylic acid could be determined. The step 2 product NMR was mainly used as a method to further prove the presence of the methacrylate functionality. Peaks in the 5.5-6.5 ppm range correspond to the =CH2/methylidene hydrogens, which further indicate the presence of the methacrylate functionality.

### Example 2: Formulation of Photopolymer Resin

Formulations of the photopolymer resin were made using a reactive diluent, methacrylic anhydride, to solubilize the step 2 polyanhydrides and photoinitiator. A proof-of-concept study was completed to ensure that the materials would photopolymerize in the presence of UV light and to develop a base material and a material profile for printing. The formulation of a base material entailed the production of a 1% Irgacure 819 (photoinitiator) in the reactive diluent methacrylic anhydride (MA) material. Roughly 1 mL of this photopolymer resin was cured in a small vial by placing it in a UV oven to ensure that the material crosslinked and formed a solid material. This step was completed for all trial formulations to ensure that new mixtures of resins polymerized. The photopolymerization usually resulted in a glassy crystalline thermoset within the vial that would firmly adhere to the bottom of the vial. A similar proof of concept study was completed with the photoinitiator TPO, but the low efficiency of TPO was not able to efficiently create a thermoset upon irradiation with light.

To assess the optimal amount of Irgacure 819 PI in the resin, formulations with 0.1, 0.3, 0.5, 0.7, and 1.0 wt % PI were made. Using Chitubox (a free to download open access LCD slicing software), the optimal exposure was ascertained for each % loading of PI. Too low of an exposure resulted in only a small amount of material being able to adhere to the build table. Once enough seconds of irradiation was reached, the disk was then able to be produced while maintaining dimensional accuracy.

The amount of time that was required to produce a given disk varied significantly between the 0.1% and 1% wt % loading of PI. The type of photoinitiator that was used caused the higher wt % loadings of PI to appear yellow. The significant amount of time that was required to print with this base material, preference was given to the shorter exposure times to minimize the time that was required to prepare a given sample. Thus, for the remainder of this study the 1.0 wt % PI formulation was used with the material setting that was generated.

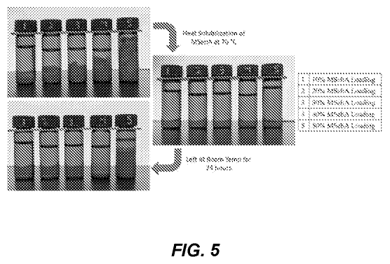

The solid waxy state of the step 2 methacrylated polyanhydrides, production of the photopolymer resin that are used in this study was dependent on the amount of this material that was able to be loaded into the methacrylic anhydride. Loadings of the step 2 sebacic material were added into the reactive diluent in 10% intervals up to 50 wt % loading (FIG. 5). To solubilize these materials, the vials were heated and agitated at 70° C. until the resin appeared to have no solid remaining. To assess the stability of the resin formulations, these vials were then left in a dark cool environment for 24 hours. As shown in the figure the 10-30 wt % loadings of these materials were stable over the period of 24 hours, as they did not have the synthesized polyanhydride crash out of the solution. The 40 and 50 wt % loadings have clear polyanhydride crashing out of the solution. Thus logically, up to 30 wt % loadings of these polyanhydrides were able to be added to a formulation.

Based on a similar study of the other synthesized polyanhydrides, 10 wt % loadings of each of the polyanhydrides were added to MA in vials. These vials were also heated and agitated until all the polyanhydrides was able to be dissolved. During this testing the dodecanedioic formulation had significant difficulty being dissolved into the reactive diluent. After about 30 minutes of heating and agitation was the MDodA polymer able to be completely dissolved into the photopolymer resin. Thus, due to the difficulty with making this formulation, all subsequent polyanhydride photopolymer formulations were kept at 10 wt % loading of the polyanhydride to be consistent across the different batches.

Based on these proof-of-concept studies, bulk materials using the base material of 1% PI in MA were made for testing. Four 100 mL batches of photopolymer resin were made, and each batch consisted of either the base material (no polyanhydride added), 10 wt % loading methacrylated suberic product, 10 wt % loading methacrylate sebacic product, or 10 wt % loading methacrylated dodecandioic. These formulations were made using the aforementioned procedure with an increased volume of material.

### Example 3: Degradability of Resins

Degradation disks, 15 mm in diameter and approximately 1.85 mm in height were produced for the degradation study. These samples were produced in bulk using the Anycubic large volume Photon setup. After production the disks were lightly dried using a KimWipe to remove excess resin. The dried samples were then post cured in a UV cure oven for 2 minutes before being removed and placed in a desiccator. Visual analysis of the samples was completed to determine which disks were practical for testing. Samples that exhibit excessive cracks or deformities or that were not within 0.3 mm of the intended height or diameter of the disk were excluded from further testing. The average mass of the disks was 0.4 g with a tolerance of 0.1 g being acceptable. The disks averaged 2.00 mm in height with a tolerance of 0.3 mm from the 1.85 mm ‘ideal’ being considered acceptable. The diameters of the disks averaged 14.9 mm with a tolerance of 0.03 mm.

A preliminary degradation study using the base formulation was completed. This effort entailed the production of 3 batches of 18 disks of the base formulation that were degraded in 100 mL of PBS at 37° C. in an orbital shaker at 80 rpm. Degradation of the preliminary 1% PI in MA disks proceeded over 18 hours with hourly intervals. After 18 hours, a max of 2.87% mass loss was observed. The degradation of the samples mass loss % versus time, in hours, had a slope of 0.09 with an R2 value of 0.92. The pH of the PBS buffer was also recorded after degradation. After the 18-hour degradation the pH of the PBS averaged around 7.2. Due to the small amount of mass loss that was observed over the 18-hour period for the base formulation, further degradation studies were run at 50-hour time frames with 5-hour intervals.

Upon removal and drying of the MA disks that had degraded, the surface layer had cracked and broke. As this cracking only occurred in the surface layer, it may be an indication of the surface-degradation mechanism that polyanhydrides are known to exhibit. However, over 18 hours the MA disks did not show any significant surface-layer cracking. Thus, these materials may need to have degraded for a significant amount of time or have absorbed a sufficient amount of water within the surface layer (time dependent) to exhibit the surface cracking behavior.

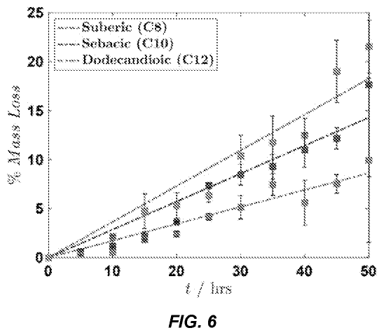

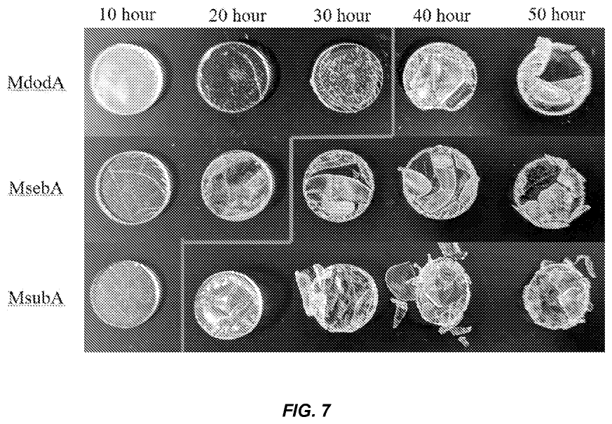

Degradation of the 10 wt % loaded polyanhydrides proceeded over 50 hours with 5-hour intervals (FIG. 6). After the 50 hours had passed, the suberic formulation had a 21.5% average mass loss, and the average pH dropped to 5.5; the sebacic formulation had a 17.7% average mass loss, and the average pH dropped to 5.6; and the dodecanedioic had a 9.9% average mass loss, and the average pH dropped to 6.3. The slopes of the mass loss % versus time for the suberic, sebacic, and dodecanedioic disks were 0.37, 0.29, and 0.17 with R2 values of 0.97 for all of these slopes. Degradation rates of the three synthesized polyanhydrides showed increasing rates of degradation with decreasing R group length. The trend of declining rates with larger R group lengths is thought to be a result of the decreasing anhydride group concentration within the final disk, thus decreasing the rate of degradation. The polyanhydride-degradation disks after drying also showed the surface layer cracking/fragmentation at significant degradation times (FIG. 7). The surface cracking for the longer R group lengths was delayed until longer degradation times had occurred, further depicting the trend that was observed with the degradation rates of the polyanhydrides.

The inventions being thus described, it will be obvious that the same may be varied in many ways. Such variations are not to be regarded as a departure from the spirit and scope of the inventions and all such modifications are intended to be included within the scope of the following claims.

The above specification provides a description of the manufacture and use of the disclosed compositions and methods. Since many embodiments can be made without departing from the spirit and scope of the inventions, the inventions reside in the claims.

What is claimed is:

1. A photo-curable resin composition comprising:
a methacrylated anhydride of formula (I) 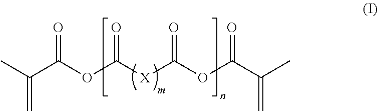
or an acrylated anhydride of formula (II) 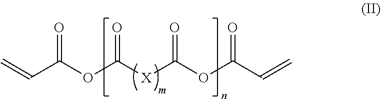
wherein X is a carbon, a C2-C12 alkane, or a C2-C12 alkene; and wherein n is an integer of 1 or more.

2. The composition of claim 1, wherein X is a C4 alkane, C5 alkane, C6 alkane, C9 alkane, or C10 alkane; and wherein n is 1, 2, 3, 4, 5, or 6.

3. The composition of claim 1, further comprising an optical absorber in an amount from about 0.01 wt. % to about 15 wt. %.

4. The composition of claim 1, wherein the composition comprises a photoinitiator in an amount from about 0.01 wt. % to about 15 wt. %.

5. The composition of claim 4, wherein the photoinitiator has an absorbance wavelength of from about 250 nm to about 450 nm, or from about 780 nm to about 800 nm.

6. The composition of claim 5, wherein the photoinitiator comprises Irgacure 819, Irgacure 1173, Irgacure 2959, Irgacure 651, TPO-L, Ivocerin, BAPO, or a mixture thereof.

7. The composition of claim 1, wherein the composition comprises a reactive diluent comprising an acrylate, a methacrylate, an epoxide, or a mixture thereof.

8. The composition of claim 1, wherein the composition further comprises an additional functional ingredient comprising a polymerization inhibitor, polyvinylpyrrolidone, calcium carbonate, carbon nanofibers, graphene, magnetic particles, a pigment, a dye, or a combination thereof.

9. The composition of claim 1, wherein the composition comprises from about 5 wt % to about 30 wt % of the methacrylated anhydride of formula (I) or the acrylated anhydride of formula (II).

10. A degradable three-dimensional object comprising the composition of claim 1, wherein the composition has been cured by exposure to light having a wavelength of from about 250 nm to about 450 nm or from about 780 nm to about 800 nm.

11. A method of preparing a degradable three-dimensional object, the method comprising:
providing a photo-curable resin composition comprising a methacrylated anhydride of formula (I) 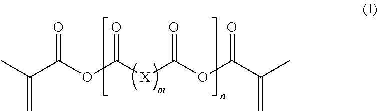
or an acrylated anhydride of formula (II) 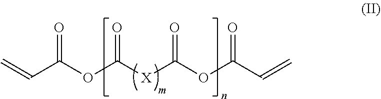
wherein X is a carbon, a C2-C12 alkane, or a C2-C12 alkene; and wherein n is an integer of 1 or more; and
a photoinitiator;
forming a two-dimensional or three-dimensional object from the composition; and
exposing the object to light to cure the composition.

12. The method of claim 11, wherein X is a C4 alkane, C5 alkane, C6 alkane, C9 alkane, or C10 alkane; and wherein n is 1, 2, 3, 4, 5, or 6.

13. The method of claim 11, wherein the photoinitiator comprises Irgacure 819, Irgacure 1173, Irgacure 2959, Irgacure 651, TPO-L, Ivocerin, BAPO, or a mixture thereof.

14. The method of claim 13, wherein the composition comprises the photoinitiator in an amount from about 0.01 wt. % to about 15 wt. %.

15. The method of claim 11, wherein the composition comprises a reactive diluent comprising an acrylate, a methacrylate, an epoxide, or a mixture thereof.

16. The method of claim 11, wherein the composition comprises from about 5 wt % to about 30 wt % of the methacrylated anhydride of formula (I) or the acrylated anhydride of formula (II).

17. The method of claim 11, wherein the light comprises a wavelength from about 250 nm to about 450 nm or from about 780 nm to about 800 nm.

18. The method of claim 11, wherein the forming is by 3D printing or photon printing.

19. The method of claim 18, wherein the 3D printing comprises stereolithography, laser printing, or digital light processing.

20. The method of claim 11, wherein the forming is by dip coating, spray coating, blade coating, molding, bulk curing, or a combination thereof.
